(19) United States
(12) Patent Application Publication
(10) Pub. No.: US 2018/0266397 A1
(43) Pub. Date: Sep. 20, 2018

(54) WIND FARM AIRCRAFT BEACON SYSTEM AND WIND FARM HAVING SAID SYSTEM AND METHOD FOR PROVIDING A WIND FARM WITH A BEACON

(71) Applicant: Wobben Properties GmbH, Aurich (DE)

(72) Inventors: Joachim RISTAU, Wilhelmshaven (DE); Erich STÜRENBURG, Aurich (DE); Stephan HARMS, Upgant-Schott (DE)

(21) Appl. No.: 15/762,038

(22) PCT Filed: Aug. 3, 2016
(86) PCT No.: PCT/EP2016/068476

§ 371 Date: Mar. 21, 2018

(30) Foreign Application Priority Data
Sep. 30, 2015 (DE) 10 2015 116 596.1

(51) Int. Cl. F03D 80/10; F03D 7/04; G01S 13/93; G01S 15/93; G01S 1/68

(52) U.S. Cl. CPC F03D 80/10; F03D 7/048; G01S 13/93; F05B 2270/806; G01S 1/68; F05B 2240/14; F05B 2270/805; G01S 15/93

(57) ABSTRACT

A wind farm aircraft beacon system, a wind farm having the wind farm aircraft beacon system and a method for providing a wind farm with a beacon are provided. A plurality of aircraft beacon devices are provided and at least one transmitting station is used to emit electromagnetic waves and/or sound waves. A number of receiving stations are provided that are at least a multiple of the number of transmitting stations. At least two receiving stations receive electromagnetic waves and/or sound waves and an evaluation device detects for flying object positions by evaluating emitted and received electromagnetic waves or sound waves, for example, using transit time determination. The wind farm aircraft beacon system also comprises a switching device for switching at least one of the aircraft beacon devices on or off on the basis of the flying object positions.

### BACKGROUND

### Technical Field

The invention relates to a wind farm aircraft beacon system, i.e. to a system for flight restriction beaconing for a wind farm, and to a wind farm having such a wind farm aircraft beacon system. The invention furthermore relates to a method for beaconing a wind farm.

### Description of the Related Art

Systems for flight restriction beaconing, also referred to below for brevity as systems for aircraft beaconing or aircraft beacon systems, which are used for beaconing the wind power installations of a wind farm, are known according to the prior art.

The aircraft beaconing comprises one or more lights, which are arranged at the wind power installations and are used to make flying objects aware of wind power installations situated in the region of the flight path in poor visibility or nighttime darkness.

A multiplicity of different aircraft beacon systems for wind farms are known. According to a first system, for example, controlling of the lights of the aircraft beacon system is carried out in such a way that they are switched off during the day in order to save energy. However, daytime-dependent control of the aircraft beaconing entails the problem that poor visibility, for which it is necessary to switch the aircraft beaconing on, may also occur during the day. Furthermore, continuous beaconing of the wind power installations during the night is a nuisance for residents in the vicinity of the wind power installations.

More refined proposals have therefore already been made for switching the aircraft beaconing on when it is required. Such a requirement occurs when a flying object is approaching the vicinity of a wind power installation or a wind farm.

The approach of the flying objects is identified according to these known aircraft beacon systems, for example, by means of passive secondary radars, which detect a transponder signal of a flying object and switch the lights on or off as a function of the detection. These systems, however, are dependent on external signals in this case the transponder signal of the flying object.

Furthermore, independent systems are also known, in which a plurality of active radars are provided at each wind power installation of a wind farm, so that it is possible to dispense with a transponder signal of the flying objects. Active radars, however, are very expensive.

Because of the high cost of active radars, other alternative systems have been proposed, which, for example, provide microphone arrays for detecting flying objects by their emitted noise and therefore switching the lights on or off as a function of the detection of noise.

Although various solutions for wind farm aircraft beacon systems are already known, either these are very expensive to implement, or malfunctions cannot entirely be ruled out. For example, in the case of passive radar systems, transmission units of the flying objects, for emitting the transponder signal, may fail.

It is therefore desirable to find an alternative to the already known systems, by which on the one hand, malfunctions, for example due to lack of transponder signals, are minimized, and on the other hand, a favorable and reliable wind farm aircraft beacon system is provided.

The German Patent and Trade Mark Office has found the following prior art searching the priority application of the present applications: DE 10 2011 086 990 A1 and DE 10 2013 004 463 A1.

### BRIEF SUMMARY

A wind farm aircraft beacon system, i.e., a system for flight restriction beaconing of the wind power installations of a wind farm, is provided.

The wind farm aircraft beacon system comprises a plurality of aircraft beacon devices which, in particular, have lights. The wind farm aircraft beacon system furthermore comprises at least one transmission station for emitting electromagnetic waves, in particular radar waves, and/or emitting sound waves. Furthermore, at least two reception stations are provided for receiving electromagnetic waves, in particular reflected radar waves, and/or reflected sound waves.

The number of reception stations is at least a multiple, in particular at least an integer multiple, i.e., at least two times, particularly preferably at least three times, the number of transmission stations. Accordingly, in the case of one transmission station at least two reception stations are provided, in the case of two transmissions at least four reception stations are provided, in the case of three transmission stations at least six reception stations are provided, etc.

A wind farm aircraft beacon system furthermore has an evaluation device by means of which the positions of flying objects, i.e., flying object positions, can be detected. The evaluation device detects the flying object positions by evaluating the electromagnetic waves emitted by the transmission station and received by the reception station, and/or by evaluating the sound waves emitted by the transmission station and received by the reception station. Preferably, to this end, a time-of-flight determination of the electromagnetic waves or sound waves is carried out. By means of at least one switching device, at least one of the aircraft beacon devices is switched on or off as a function of the flying object positions detected by the evaluation device.

For a wind farm consisting of a plurality of wind power installations, a plurality of radar systems respectively consisting of a transmitter and a receiver are usually provided, in order to ensure reliable monitoring of the airspace despite the “shadowing” of individual radar receivers by the powers and the rotor blades of the wind power installations.

Yet since the use of passive radars—as already described above—it is not possible entirely without errors and the use of a multiplicity of active radars is very expensive, the solution provided herein represents a reliable and at the same time economical alternative.

Specifically, only one transmission station is provided, or very few transmission stations, for example, two or three, with which electromagnetic waves or sound waves are emitted, so that in contrast to the passive radar solution a constant or controllable “source” of electromagnetic waves or sound waves is provided. In contrast to a failing flight transponder, failure of the transmission station or transmission stations would immediately be noticeable. It would, therefore, be possible to react immediately to the fault situation of a failing transmission station, for example, by switching the aircraft beacon devices on permanently.

Furthermore, besides the transmission station or stations, a plurality of relatively favorable reception stations are used for receiving the electromagnetic waves, in order to achieve good coverage of the air region to be monitored.

To this end, the reception stations may be distributed in the wind farm as a function of the positions of the wind power installations of a wind farm. With the evaluation device and the switching device, aircraft beacon devices are then switched on or off as a function of the detected flying object positions.

According to one embodiment, flight paths of flying objects are identified in the evaluation device by means of time-of-flight determination of the emitted and received electromagnetic waves or sound waves. The flying objects may, for example, be tracked accurately, so that not only can objects entering the region of the wind farm and emerging therefrom be tracked accurately, but, for example, incoming and outgoing flying objects may even be counted and the numbers may be compared.

Furthermore, according to one preferred embodiment, it is even possible that, in cases in which a flight path does not emerge again from the region of the wind farm, which may for example be the case when a rescue helicopter lands, the aircraft beaconing remains switched on until the helicopter has departed from the region of the wind farm. According to another embodiment, however, the aircraft beaconing remains switched on only for a predefined period of time, for example, one day, since the case may also be envisioned that a flying object lands in the region of the wind farm and is then transported away on the ground, so that the flight path will never emerge from the region of the wind farm.

According to one advantageous embodiment, the transmission station and the reception station are configured to be arranged at or on a nacelle of a wind power installation. Such an arrangement of the transmission station and reception stations increases the acceptance of the wind farm aircraft beacon system by the public, since the electromagnetic waves are emitted further away from the ground below, so that a supposed effect on persons on the ground by the electromagnetic waves is reduced. Furthermore, the “shadowing” of individual reception stations by the tower per se is counteracted. Because of this “shadowing”, it is no longer necessary—as is currently usual—to arrange three radar receivers, arranged offset by 120 degrees, around the tower.

According to one advantageous embodiment, the transmission station comprises two active radars arranged at a distance from one another. In this way, it is possible for emitted electromagnetic waves to be emitted redundantly from two points. Obstruction of emitted electromagnetic waves by the rotor blades of the wind power installation at which the transmission station is arranged, but also by rotor blades of other wind power installations of the wind farm, is therefore counteracted. The active radars are advantageously pulse radars, which emit pulses for range measurement according to the time-of-flight principle.

According to another advantageous embodiment, each active radar respectively comprises a transmitter with a horizontal aperture angle of 360 degrees for emitting electromagnetic waves, and advantageously also a receiver with a horizontal aperture angle of 360 degrees for receiving electromagnetic waves.

According to another embodiment, the transmitter of an active radar also comprises a vertical aperture angle for emitting electromagnetic waves. The receiver also has a vertical aperture angle for receiving electromagnetic waves. The vertical aperture angles are preferably preadjustable. According to one preferred embodiment, a vertical aperture angle corresponds to an angle of between 60 and 80 degrees.

The transmission station is therefore used for emitting electromagnetic waves, and in particular also for receiving emitted electromagnetic waves reflected from any direction onto the wind power installation at which the transmission station is for example arranged.

According to another embodiment, besides precisely one transmission station, the aircraft beacon system comprises at least three reception stations. It is therefore possible to monitor an airspace around a wind farm, which is for example arranged essentially square, with a relatively low cost outlay. To this end, the reception stations are in particular configured to be arranged respectively at one of the wind power installations which has a corner position in the wind farm. The transmission station is then configured to be arranged at the wind power installation that is arranged in the region of the remaining fourth corner of the wind farm, at which no reception station is provided.

Since, according to one embodiment, the transmission station is also used for receiving electromagnetic waves, all four corners of the wind farm are equipped with receivers for receiving electromagnetic waves. Flying object positions from all directions can therefore be detected without being obstructed by the wind farm itself. This takes place by the electromagnetic waves and/or sound waves emitted by the transmission station being reflected at the flying objects and the reflected electromagnetic waves and/or sound waves in turn being received by the wind farm aircraft beacon system.

By the use of a single transmission station and a plurality of reception stations, such a system is very favorable and nevertheless very reliable.

Furthermore, according to another advantageous exemplary embodiment, at least two or precisely two of the reception stations are configured to be arranged with respect to one another with a height difference at different wind power installations. A height difference of the reception stations with respect to one another is preferably more than 5, 10 or 20 meters. A height difference is particularly advantageously from 40 to 60 meters. By such an arrangement, the altitude of a flying object can easily be deduced in a straightforward fashion by comparing the time-of-flight difference of received electromagnetic waves and/or sound waves.

According to another embodiment, the wind farm aircraft beacon system respectively comprises precisely one reception station for each wind power installation of the wind farm. It is therefore possible to switch the aircraft beacon device of a wind power installation on and off merely as a function of the electromagnetic waves and/or acoustic waves received by the reception station of this wind power installation.

To this end, according to one particular embodiment, each wind power installation also has its own evaluation device, with which the flying object positions are detected merely with the aid of the respective reception station, and its own switching device, with which the aircraft beacon device is switched on and off merely with the aid of the detected flying object positions with the respective evaluation device.

The failure of one reception station, one evaluation device or one switching device of an individual wind power installation would therefore not lead to failure of the entire wind farm aircraft beacon system.

According to another embodiment, the reception stations respectively have two passive radars arranged at a distance from one another. “Shadowing” of individual reception stations by the towers or rotor blades of the same wind power installation or other wind power installations of the same wind farm is therefore counteracted.

According to another embodiment, each passive radar respectively has a receiver with a horizontal aperture angle of 360 degrees and is used for receiving electromagnetic waves from this aperture angle. In this way, it is possible to receive electromagnetic waves from any angle of incidence onto the wind power installation.

According to another embodiment, the receiver of the passive radar also comprises a vertical aperture angle for receiving electromagnetic waves. The vertical aperture angle is preferably preadjustable. According to one preferred embodiment, a vertical aperture angle corresponds to an angle of between 60 and 80 degrees.

According to another embodiment, the wind farm aircraft beacon system comprises at least one receiver for receiving signals of mobile transmitters, in particular radio flight transponders. The mobile transmitter is therefore, for example, a radio flight transponder which may be arranged in flying objects and emits an identifier, for example, a 24-bit identifier, with which the flying object can be identified uniquely, or at least the type of flying object can be identified. The receiver of the wind farm aircraft beacon system receives this signal and can therefore uniquely classify an object detected by the transmission and reception station and track its flight path.

Flying objects which, for example, cross their flight path can, therefore, be distinguished clearly from one another.

Furthermore, redundant identification of flying objects in the region of the wind farm is possible, since on the one hand they can be identified by means of the signals of the mobile transponders and on the other hand by means of the evaluation apparatus flying objects entering the region of the wind farm.

According to another aspect of this exemplary embodiment, the flight paths of flight objects which are detected by means of the signals of mobile transmitters and also by means of the evaluation apparatus may be stored for predetermined periods of time, for example, one year or six months.

The stored data may be interrogated during a maintenance interval of the wind farm aircraft beacon system, and are then used to verify correct functioning of the wind farm aircraft beacon system. To this end, for example, the positions detected for the same flying object in the different ways at the same times are compared. In the event of a match, a correctly functioning wind farm aircraft beacon system is assumed, while if there is not a match it is to be concluded that there is a malfunction.

According to another embodiment, a sector can be defined in the switching device for the wind farm. This sector corresponds, in particular, to the aforementioned region of the wind farm. The switching devices are configured to then switch on, or leave switched on, at least one, a plurality or all of the aircraft beacon devices when one or more flying object positions that lie inside the predefined sector around the wind farm are detected by means of the evaluation device.

According to another embodiment, the switching device is furthermore configured to switch off, or leave switched off, at least one of the aircraft beacon devices when no flying object positions, i.e., no flying objects with positions, which lie inside the predefined sector around the wind farm are detected by means of the evaluation device.

By the definition of a sector, a region around the wind farm is therefore established which, for example according to statutory regulations or guidelines, is defined as a region in which the presence of a flying object must lead to the aircraft beacons of wind power installations being switched on. The sector corresponds to a three-dimensional space or region, which is defined for example by x, y and z coordinates in the switching device.

Such a sector therefore comprises, for example, a region or space whose lower side is defined by the ground surface on which the wind power installations of the wind farm are installed. The upper side of the sector is formed by a surface which lies in its entirety at least several hundred meters above the lower side, for example, 600 meters above the lower side. The side surfaces of the sector are furthermore defined in such a way that each of the side surfaces lies at least a few kilometers, in particular four kilometers, away from a contour, defined by the outer-lying wind power installations, of the wind farm in the horizontal direction.

By the side surfaces together with the upper side and lower side of the sector, a three-dimensional space or region is therefore defined, the horizontal extent of which extends over the entire wind farm with a margin of at least several kilometers, in particular four kilometers, from the outer-lying wind power installations of the wind farm.

If aircrafts enter this region, i.e., the defined sector around the wind farm, the aircraft beacon devices are switched on in order to warn the flying object. If there are no longer any flying objects in the region, i.e., the defined sector, the aircraft beacon devices are switched off. Warning of flying objects at the appropriate time is therefore ensured, while additionally saving on energy costs.

According to another embodiment, each wind power installation of the wind farm has precisely one aircraft beacon device, which comprises in particular two lights, which preferably each emit over 360 degrees horizontally. A flying object can therefore advantageously identify each individual wind power installation in poor visibility, and adapt the flight path accordingly.

According to another embodiment, a plurality of subsectors can be defined in the switching device, respectively, for one or more wind power installations of the wind farm. In particular, for each wind power installation, its own subsector can be defined in the switching device. Each subsector corresponds to a three-dimensional space or region, which is defined by x, y and z coordinates in the switching device.

To this end, each subsector comprises, for example, a region or space whose lower side is defined by the ground surface on which the wind power installation assigned to the respective subsector or the wind power installations assigned to the respective subsector are installed. The upper side of each subsector is respectively formed by a surface which lies in its entirety at least several hundred meters above the lower side of the respective subsector, for example 600 meters above the lower side. The side surfaces of each sector are defined in such a way that they lie at least a few kilometers, in particular four kilometers, away from the wind power installation or each of the wind power installations assigned to the respective subsector in the horizontal direction. Accordingly, each subsector corresponds to a three-dimensional space, although the subsectors may naturally also overlap.

The switching device is furthermore configured to switch on, or leave switched on, the aircraft beacon device of the wind power installation or wind power installations when one or more flying object positions which lie inside the subsector defined for the respective wind power installation or wind power installations are detected by means of the evaluation device.

According to another embodiment, the switching device is furthermore configured to switch off, or leave switched off, the aircraft beacon device of the wind power installation or wind power installations when no flying object positions which lie inside the subsector defined for the respective wind power installation or wind power installations are detected by means of the evaluation device.

Selective switching of the aircraft beacon devices of the wind power installations on and off is, therefore, possible. This is particularly advantageous for very large wind farms, which, for example, have a propagation direction of several kilometers. In such wind farms, it is therefore important to switch the aircraft beacon devices of the wind power installations on only when a flying object enters the subsectors of the respective wind power installations.

It is thus possible, in a wind farm which, for example, has an extent from west to east of 10 kilometers and which a flying object is approaching in the region of the western boundary of the wind farm, initially to switch on only the westerly lying wind power installations, which are for example at a distance of about 4 to 5 kilometers from the flying object. The aircraft beacon devices lying further to the east may initially remain switched off, so as to save energy for the operation of these aircraft beacon devices.

According to another embodiment, a topology of objects and geodata can be stored in the switching device. Preferably, the topology of objects and geodata of a defined sector and/or of defined subsectors of the wind farm can be stored.

Furthermore, the evaluation device is configured for detecting object positions and geodata by evaluating the emitted and/or received electromagnetic waves or sound waves and for transmitting the detected object positions and geodata to the switching device. Furthermore, the switching device is configured for generating a topology of objects and geodata, in particular of a defined sector and/or of defined subsectors of the wind farm, by observing the time variation of the transmitted data, or in particular by referencing the time-invariant data. These objects and geodata are therefore not flying objects, the position of which would naturally change when observed over the course of time.

Topological data are therefore stored in the switching device, with the aid of which data it is then possible to verify before switching the aircraft beacon on or off whether the flying object detected by the evaluation device is actually a flying object. For example, road or freeway routes may be taken from the topological data, and objects moving in the region of the road or freeway routes may be verified definitively as objects which are not actually flying objects.

Furthermore, the topological data are used to verify the wind farm aircraft beacon system itself. According to one embodiment, it is possible to check or verify whether the wind farm aircraft beacon system is functioning correctly, by the topological data detected by the evaluation device matching with stored topological data. In this way, for example, it is also possible to detect fog, hail or lightning, for example by establishing that the detected topological data do not match with the stored topological data.

The invention furthermore relates to a wind farm having a wind farm aircraft beacon system according to one of the embodiments above.

The invention furthermore relates to a method for beaconing, i.e., aircraft beaconing, a wind farm. According to the method, electromagnetic waves and/or sound waves are emitted by a transmission station. Furthermore, electromagnetic waves and/or sound waves are received by at least one reception station and/or the transmission station, and positions of flying objects, i.e., flying object positions, are detected by evaluating the emitted and/or received electromagnetic waves and/or sound waves with an evaluation device.

Furthermore, at least one of the aircraft beacon devices is switched on and/or off as a function of the positions of the flying object positions detected by the evaluation device.

### BRIEF DESCRIPTION OF THE SEVERAL VIEWS OF THE DRAWINGS

Exemplary embodiments of the present invention will be explained in more detail by way of example below with reference to the appended figures, in which

FIG. 1 shows a wind power installation,

FIG. 2 shows a wind farm having an exemplary embodiment of a wind farm aircraft beacon system,

FIG. 3 shows a nacelle of a wind power installation with a reception station, and

FIG. 4 shows a nacelle of a wind power installation with a transmission station.

### DETAILED DESCRIPTION

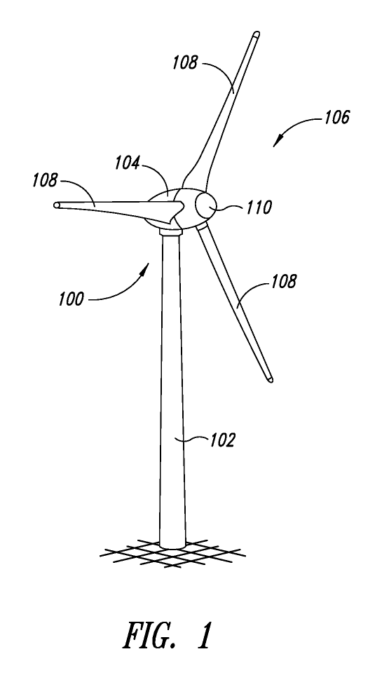

FIG. 1 shows a wind power installation 100 having a tower 102 and a nacelle 104. A rotor 106 having three rotor blades 108 and a spinner 110 are arranged on the nacelle 104. During operation, the rotor 106 is set in a rotational movement by the wind and thereby drives a generator in the nacelle 104.

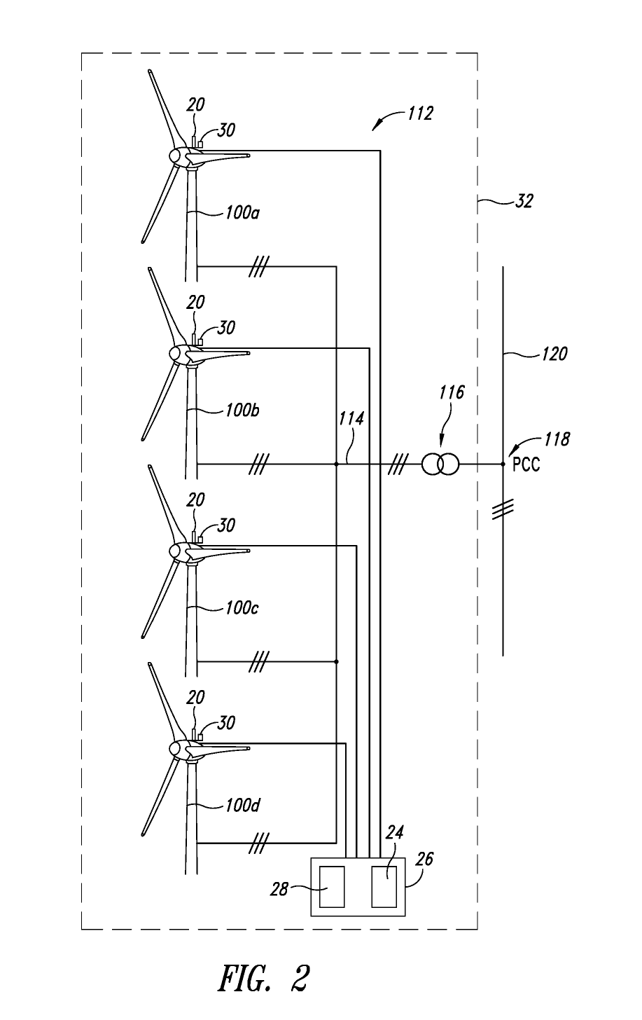

The wind power installation 100 of FIG. 1 may also be operated in conjunction with a plurality of other wind power installations 100 in a wind farm, as will be described below with reference to FIG. 2.

FIG. 2 represents a wind farm 112 having by way of example four wind power installations 100a to 100c. The four wind power installations 100a to 100d may be the same or different. The wind power installations 100a to 100d are therefore representative of, in principle, an arbitrary number of wind power installations 100 of a wind farm 112. The wind power installations 100 provide their power, i.e., in particular the current generated, via an electrical farm network 114. In this case, the respectively generated currents or powers of the individual wind power installations 100 are added up, and a transformer 116 is usually provided, which steps up the voltage in the farm in order to feed it into the supply network 120 at the feed point 118, which is also generally referred to as a PCC.

FIG. 2 it is only a simplified representation of a wind farm 112, which for example does not show any power control, even though there will naturally be power control. The farm network 114 may, for example, also be configured differently, for example by there also being a transformer at the output of each wind power installation 100, to mention only one different exemplary embodiment.

An exemplary embodiment of the wind farm aircraft beacon system is furthermore represented. In detail, the wind power installations 100a to 100c each have a reception station 20. The wind power installation 100d comprises a transmission station 22.

Electromagnetic waves are emitted by the transmission station 22, and are then, for example, reflected by flying objects. The reflected electromagnetic waves are then received by one or more of the reception stations 20, and sent to an evaluation device 24.

At least two of the reception stations 20 have a height difference with respect to one another of about 50 meters. This height difference is not represented in FIG. 2 for better clarity. The height difference is, for example, achieved by one of the reception stations 20 being arranged on a wind power installation 100 standing on elevated ground, while another reception station 20 is arranged on another wind power installation 100 which stands lower, for example, in lower ground, such as in a depression.

The evaluation device 24 is part of a control 26 of the wind farm aircraft beacon system. With this control 26, for example, the transmission station 22 for emitting the electromagnetic waves is also driven.

Flying object positions, i.e., the positions of flying objects are detected in the evaluation device 24 by evaluating the emitted and received electromagnetic waves. To this end, according to one exemplary embodiment, measurement of the time-of-flight difference from the time of emission of particular electromagnetic waves by the transmission station 22 until the reception of the reflected electromagnetic waves by the reception station 20 is recorded.

Using the known propagation speed of the electromagnetic waves and the recorded time-of-flight, it is possible to determine a distance of a flying object at which the electromagnetic waves have been reflected, with the evaluation device 24. The flying object positions can therefore subsequently be determined from these distances.

A switching device 28 is furthermore provided, which, in this case by way of example, is likewise a component of the control 26. With the switching device 28, aircraft beacon devices 30 which are arranged on the nacelle 104 of each wind power installation 100a to 100d can be switched on and off. The aircraft beacon device 30 is switched on or off as a function of the flying object positions which have been determined by the evaluation device 24.

Whether an aircraft beacon device 30 is switched on or off depends on the precise position of the flying object. To this end, a sector 32 is defined in the switching device 28. This sector 32 is represented two-dimensionally by way of example in FIG. 2, although it usually has three-dimensional dimensions, i.e. for example a width, a height and a depth, the wind power installations 100a to 100d being located essentially at the center of the sector 32.

The sector 32 is also represented very close to the wind power installations 100a to 100d in FIG. 2, although the outer boundary of the sector 32 may usually have a distance of several kilometers from the wind power installations at least in the horizontal direction.

If a position of a flying object, i.e., a flying object position, inside this sector 32 is now detected by the evaluation device 24, then according to this exemplary embodiment the aircraft beacon devices 30 are switched on, or remain switched on if another flying object has already been detected beforehand in the sector 32.

In the case in which there is no flying object (no longer a flying object) in the sector 32, i.e., no flying object position is detected inside the sector 32, the aircraft beacon devices 30 are switched off, or remain switched off.

Here, a sector 32 which “frames” the entire wind farm 112 is represented. According to another exemplary embodiment (not shown in FIG. 2), it is however also possible respectively to define an individual subsector for each wind power installation 100a to 100c, which is then monitored separately by the evaluation device 24.

Accordingly, the aircraft beacon 30 of a wind power installation 100a to 100c is switched on in the case in which a flying object enters the respective subsector of a wind power installation 100a to 100c, or is detected in this subsector of the wind power installation 100a to 100c. Selective switching of individual aircraft beacon devices 30 on as a function of flying object positions is therefore possible. Particularly in large wind farms which extend over an area of several kilometers, it is therefore possible for aircraft beacon devices 30 to be activated only in the part of the wind farm 112 which may actually represent a hazard for a flying object.

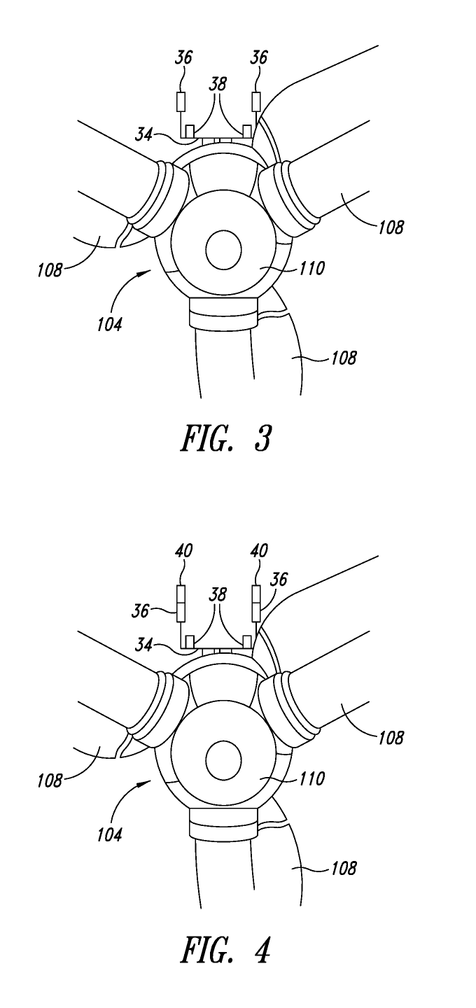

FIG. 3 shows the front view of a nacelle 104 of a wind power installation 100 in an enlarged representation. An antenna carrier 34 is arranged on the nacelle 104 and is firmly connected to the nacelle 104. The antenna carrier 34 has two receivers 36, respectively of a passive radar, which together correspond to a reception station 20. The receivers are used to collect electromagnetic waves and have a horizontal aperture angle of 360 degrees.

Furthermore, two lights 38 are provided, which together form an aircraft beacon device 30 of the wind power installation 100. By the separated arrangement of the lights 38 on the one hand, and of the receivers 36 on the other hand, the systems are duplicated, so that error-free function of the wind farm aircraft beacon system is still ensured despite the partial shadowing by the rotor blades 108.

FIG. 3 therefore represents an enlarged representation of the nacelle 104 of one of the wind power installations 100a to 100c of FIG. 2.

FIG. 4 corresponds essentially to FIG. 3, although in this case, besides the receivers 36 of the passive radars, two transmitters 40 emitting electromagnetic waves are also provided. Accordingly, the transmitters 40 and the receivers 36 together correspond to a transmission station 22. FIG. 4 is therefore the enlarged representation of the nacelle 104 of the wind power installation 100d of FIG. 2.

A wind farm 112 equipped with a wind farm aircraft beacon system comprising a plurality of reception stations 20 and a single transmission station 22 therefore allows control of the aircraft beacon devices 30 of the wind farm 112 which is independent of transponder signals and other transmission signals, the wind farm aircraft beacon system at the same time obviating a multiplicity of active radars and therefore being substantially more favorable than already known solutions.

1. A wind farm aircraft beacon system of a wind farm, comprising:
a plurality of aircraft beacon devices,
at least one transmission station for emitting at least one of: electromagnetic waves or sound waves,
at least two reception stations for receiving the at least one of: electromagnetic waves or sound waves reflected by flying object, a number of reception stations being at least a multiple of a the number of transmission stations,
an evaluation device for detecting a position of the flying object by evaluating a time-of-flight of the at least one of: emitted or received electromagnetic waves or sound waves, and
at least one switching device for switching at least one of the plurality of aircraft beacon devices on or off based on the position of the flying object detected by the evaluation device.

2. The wind farm aircraft beacon system as claimed in claim 1, wherein the at least one transmission station or the at least two reception stations are arranged at or on a nacelle of a wind power installation.

3. The wind farm aircraft beacon system as claimed in claim 1, wherein the at least one transmission station includes two active radars that are pulse radars arranged at a distance from each other.

4. The wind farm aircraft beacon system as claimed in claim 3, wherein each active radar respectively includes transmitter with a horizontal aperture angle of 360 degrees for emitting the electromagnetic waves and a receiver with a horizontal aperture angle of 360 degrees for receiving the electromagnetic waves reflected by the flying object.

5. The wind farm aircraft beacon system as claimed in claim 1, wherein the at least two reception stations include three reception stations.

6. The wind farm aircraft beacon system as claimed in claim 5, wherein the at least two reception stations are arranged with a height difference of 40 to 60 meters respect to each other.

7. The wind farm aircraft beacon system as claimed in claim 1, wherein only one reception station is provided for each wind power installation of the wind farm, and only one transmission station is provided for a plurality of wind farms including the wind farm.

8. The wind farm aircraft beacon system as claimed in claim 1, wherein the at least two reception stations respectively include two passive radars arranged at a distance from each another.

9. The wind farm aircraft beacon system as claimed in claim 8, wherein each passive radar of the two passive radars respectively includes a receiver with a horizontal aperture angle of 360 degrees for receiving electromagnetic waves reflected by the flying object.

10. The wind farm aircraft beacon system as claimed in claim 1, wherein the wind farm aircraft beacon system has at least one receiver for receiving signals transmitted by a mobile transmitter.

11. The wind farm aircraft beacon system as claimed in claim 1, wherein the switching device is associated with a predefined sector disposed around the wind farm, and the switching device is configured to switch on, or leave switched on, at least one of the plurality of aircraft beacon devices when positions of one or more flying object positions that lie in the predefined sector disposed around the wind farm are detected by the evaluation device.

12. The wind farm aircraft beacon system as claimed in claim 1, wherein the switching device is associated with a predefined sector disposed around the wind farm, and the switching device is configured to switch off, or leave switched off, at least one of the plurality of aircraft beacon devices when no flying object positions that lie inside the predefined sector around the wind farm are detected by the evaluation device.

13. The wind farm aircraft beacon system as claimed in claim 1, wherein only one aircraft beacon device is respectively provided for each wind power installation of a plurality of wind power installations of the wind farm.

14. The wind farm aircraft beacon system as claimed in claim 13, wherein a subsector for each wind power installation or for the plurality of wind power installations is associated with the switching device, and the switching device is configured to switch on, or leave switched on, aircraft beacon devices of the wind power installation or the plurality of wind power installations assigned to the subsector when one or more flying object positions are detected that lie inside the subsector to which the wind power installation or the plurality of wind power installations are assigned.

15. The wind farm aircraft beacon system as claimed in claim 13, wherein a subsector for each wind power installation or for the plurality of wind power installations is associated with the switching device, and the switching device is configured to switch off, or leave switched off, aircraft beacon devices of the wind power installation or the plurality of wind power installations assigned to the subsector when no flying object positions are detected that lie inside the subsector to which the wind power installation or the plurality of wind power installations are assigned.

16. The wind farm aircraft beacon system as claimed in claim 1, wherein a topology of objects and geodata are stored in the switching device, or the evaluation device is configured to detect object positions and geodata by evaluating the emitted or received electromagnetic waves or sound waves and for transmitting the detected object positions and geodata to the switching device, and the switching device is configured to generate a topology of objects and geodata of a defined sector or subsectors of the wind farm, by observing or referencing time-invariant object positions and geodata of transmitted data.

17. A wind farm having a wind farm aircraft beacon system as claimed in claim 1.

18. A method for beaconing a wind farm using a wind farm aircraft beacon system, comprising:
emitting, by at least one transmission station, at least one of electromagnetic waves or sound waves,
receiving, by the at least one transmission station or at least one reception station, the at least one of electromagnetic waves or sound waves reflected by flying object, and
detecting, by an evaluation device, a position of the flying object by evaluating the at least one of emitted electromagnetic waves or sound waves or the at least one of received electromagnetic waves or sound waves, and
switching, by a switching device, at least one aircraft beacon device on or off based on the position of the flying object detected by the evaluation device.

19. The wind farm aircraft beacon system as claimed in claim 10, wherein the mobile transmitter is a radio flight transponder.
